(19) United States
(12) Patent Application Publication
(10) Pub. No.: US 2006/0191881 A1
(43) Pub. Date: Aug. 31, 2006

(54) Method for leakage prevention of lubricating fluid, spindle motor using the method, and recording disk driving apparatus using the spindle motor

(75) Inventors: Wataru Yamauchi, Kyoto (JP); Masaaki Karuo, Kyoto (JP); Naoki Tasai, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Nidec Corporation, Kyoto (JP)

(21) Appl. No.: 11/300,637

(22) Filed: Dec. 13, 2005

(30) Foreign Application Priority Data
Dec. 13, 2004 (JP) JP-2004-360599

(51) Int. Cl. B23K 26/20; G11B 17/02

(52) U.S. Cl. 219/121.64; 360/99.08

(57) ABSTRACT

A coupling method, a spindle motor using the coupling method and a recording disk driving apparatus using the spindle motor are disclosed. An upper depression (43) and a lower depression (44) of a hub (4) are welded to an upper seal (61) and a lower seal (62), respectively. The weld zone is coated with an oil repellant (700) or welded again by laser with a smaller energy. A pore, even if generated at the weld zone, is closed by the oil repellant (700) or the opening of the pore is melted and filled thereby to prevent the leakage of a lubricating fluid (600) out of a motor.

### BACKGROUND OF THE INVENTION

1. Field of the Invention

This invention relates to a member coupling method intended to prevent the leakage of a lubricating fluid in a spindle motor having a dynamic bearing, a spindle motor using the coupling method, and a recording disk driving apparatus using the spindle motor.

2. Description of the Related Art

With the reduction in size of the recording disk drive having a spindle motor mounted thereon, the size of the spindle motor is decreasing more than ever before. At the same time, the bearing mechanism of ball bearing type is rapidly being replaced with the dynamic bearing using a lubricating fluid. The spread of portability of the recording disk driving apparatus requires a spindle motor high in shock resistance. This in turn gives rise to the demand for a highly hermetic coupling between members in contact with the lubricating fluid or the neighboring members and a coupling method having a strong fastening force of the coupling portion in order to prevent leakage of the lubricating fluid out of the motor. Generally, the welding is used as this coupling method. In the welding, however, the thermal effect is so large that a large thermal deformation is caused in coupling small members of the spindle motor or the like, and the required mounting accuracy cannot be achieved. For this reason, the laser welding having a small thermal effect has conventionally be used to couple the members having a small weld zone such as the dynamic bearing of the spindle motor requiring a high mounting accuracy, a large fastening force and a high hermeticity.

The coupling portion by the laser welding, however, is liable to generate micro pores or blow holes. In the prior art, the lubricating fluid leaks through the micro pores thereby to deteriorate the product yield.

A welding method is also available in which in order to prevent oxidation of the weld zone, the argon gas constituting an inert shield gas is sprayed on the weld zone to protect the weld zone from the atmospheric oxygen. Nevertheless, the spray of the shield gas often forms holes in the melted portion of the weld zone. As a result, the weld zone may be solidified with holes open and develops micro pores.

As described above, the weld zone is liable to develop micro pores due to a plurality of causes, with the result that part of the lubricating fluid may leak by way of the pores from inside the motor as shown in FIG. 5. The leaking lubricating fluid is liable to attach to the magnetic disk of the disk driving apparatus. Consequently, the read/write operation of the magnetic disk is adversely affected, and in the worst case, the data recorded in the magnetic disk cannot be reproduced.

The pores are as small as several μm wide and ten and several μm long and cannot be detected in the spindle motor fabrication process. In addition, even the precise inspection in the spindle motor inspection process cannot detect and exclude the pores completely.

### BRIEF SUMMARY OF THE INVENTION

This invention can provide a method of fabricating a spindle motor for preventing a leakage of the lubricating fluid from a welded portion between members, the spindle motor having a low yield using the method of fabricating a spindle motor and a recording disk driving apparatus using the spindle motor.

The method of forming a welded portion between the members according to the invention uses a welding process for the members in contact with the lubricating fluid. This welding process keeps apart the lubricating fluid and a dry area outside of the bearing where no lubricating fluid is touching the surface of the members.

According to the invention, the method including a welding process of welding one of said members at a predetermined portion to form said welded portion by applying heat from a surface of the dry area.

According to the invention, the method including a covering process of covering at least a part of the surface of said welding portion by putting solidifiable liquid material thereon, the surface being surrounded by said dry area and a solidifying process of solidifying said liquid material covering the surface of said welded portion. Also, after welding process, the method including a remelting process of remelting at least a part of a surface of said welded portion by applying heat from a surface of dry area and a solidifying process of solidifying said remelted portion of said welded portion.

The solidifying process according to the invention is solidified by coating a solidifiable liquid such as oil repellant into organic solvent, resin or adhesive on the surface of the welded portion.

In the solidifying process according to the invention, focused energy beam is applied to said predetermined portion for applying said heat and applied to a surface of melted portion for remelting said surface. Further, in moving from the starting point to the finish point on a predetermined welding line, the focused energy beam may be progressively reduced from the portion of the starting point.

The method of the invention is applicable to a spindle motor including a rotary member rotated around a rotational axis, a dynamic bearing mechanism for rotatably supporting the rotary member by the dynamic pressure through the lubricating fluid and a stationary member.

The spindle motor using the member coupling method according to the invention is mounted on a recording disk driving apparatus including a recording disk fixed on the rotary member and rotated on the same axis as the rotary shaft, a magnetic head for writing/reading data magnetically into and from the recording disk, an arm for supporting the magnetic head, an actuator adapted to move the magnetic head and the arm in peripheral direction and a housing for containing these component parts.

### BRIEF DESCRIPTION OF THE SEVERAL VIEWS OF THE DRAWINGS

FIG. 1 is a diagram showing the welding process used to the laser beam according to the invention;

FIG. 2 shows the welding portion of the laser beam according to the invention;

FIG. 3 is a sectional view, cut away in axial direction, schematically showing an example of the spindle motor used in the method according to an embodiment of the invention;

FIG. 4 is a diagram showing the weld portion covered with oil repellant according to the invention;

FIG. 5 is a diagram showing a case in which a pore is generated in the welded portion according to the prior art; and

FIG. 6 shows a recording disk driving apparatus having mounted thereon a spindle motor using the method according to the invention.

### DETAILED DESCRIPTION OF THE INVENTION

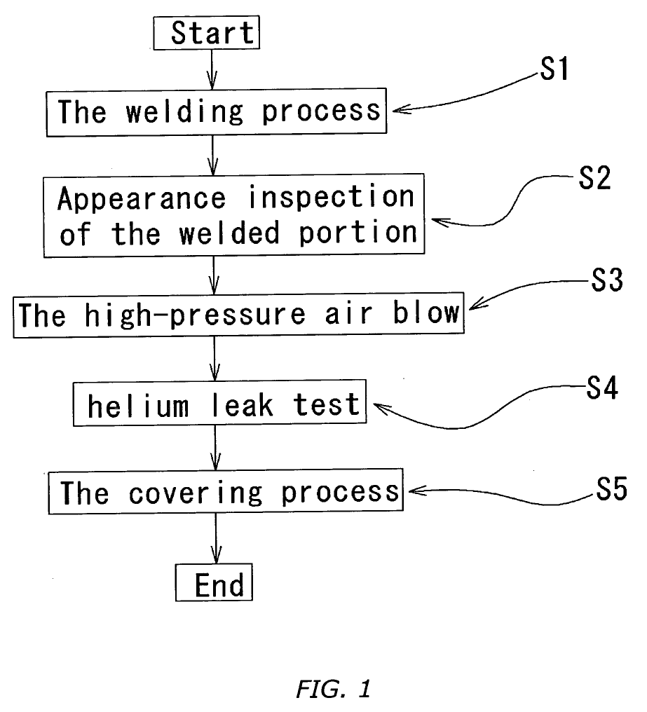

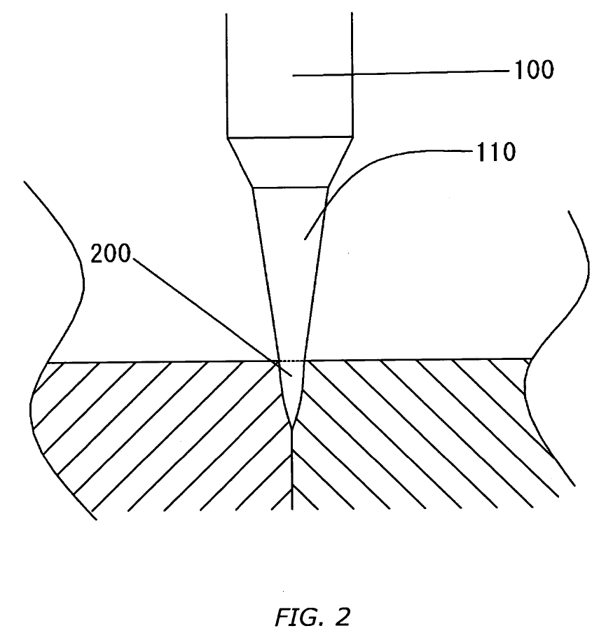

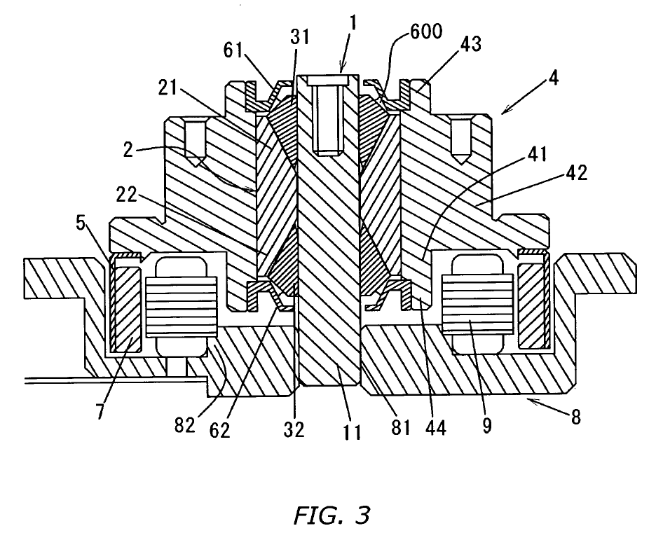

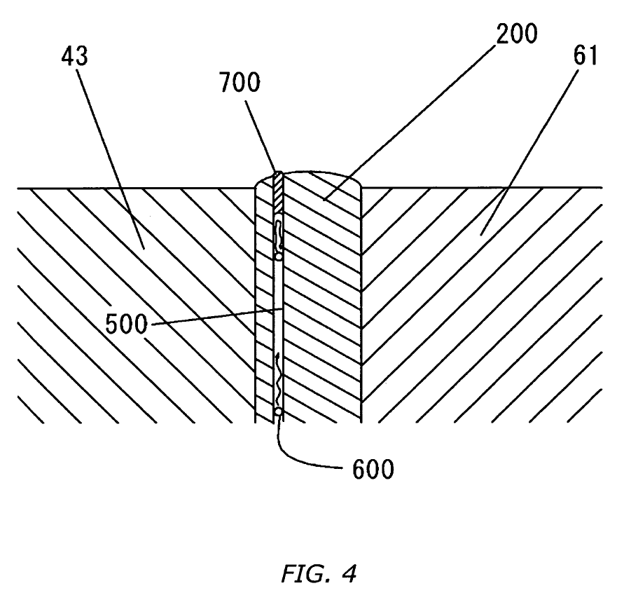

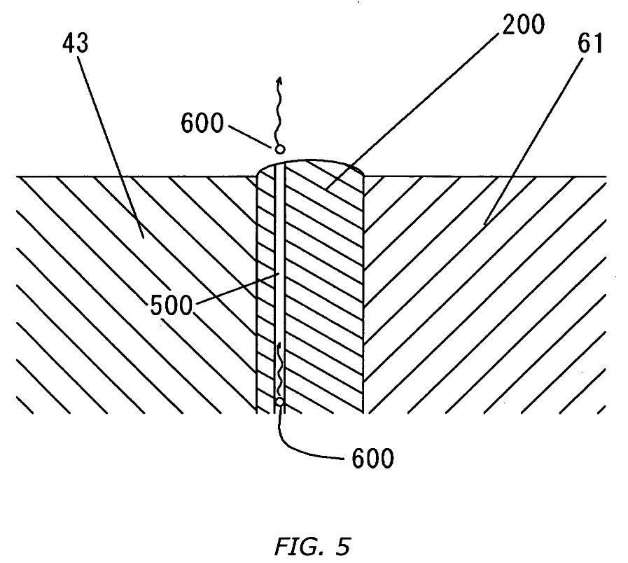

The welding process according to the invention is shown in FIG. 1. The focused energy beam as a laser beam for welding the members is shown in FIG. 2. An example of the spindle motor used in the method according to an embodiment of the invention is shown in FIG. 3. The relation between the oil repellant and the lubricating fluid upon generation of pores at the welded portion of the members according to the invention is shown in FIG. 4. Also, the conventional case in which no oil repellant is covered at the welded portion is shown in FIG. 5.

First, with reference to FIGS. 1 and 2, the welding process according to the invention is explained.

In FIG. 1, the welding process used the laser beam is welded between the members (step S1). This welding process used the laser beam is shown in FIG. 2. In FIG. 2, a focusing system 100 focuses the laser beam generated from a laser oscillator (not shown) and radiates a laser 110. The laser beam 110 is radiated while being reduced progressively toward the welded portion 200. Around the welded portion 200, nitrogen constituting an inert gas functioning as a shield gas is sprayed toward the welded portion 200. By spraying nitrogen, the oxidation of the weld portion is prevented. In addition, the pores generated in the welded portion 200 are suppressed. The shield gas, however, the poses the problem that the welded portion is formed with the pores as described above. As a solution to this problem, nitrogen is used as the shield gas. The nitrogen molecules are smaller than those of the argon gas used in the prior art, and therefore the pores generated in the welded portion 200 can be reduced in size.

Also, in the case where the welding process is conducted in circumferential direction, the welded portion 200 at the starting and finish points may be superposed one on the other. The superposed welded portion receives more heat and generates more thermal stress than the other portions. As a measure against this, energy of the laser beam is progressively reduced in what is called the fade-out process toward the end of the welded operation. The fade-out operation can minimize the heat input of the superposed portion. As a result, the thermal stress generated in the welded portion is suppressed. Thus, this welding process with high mounting accuracy of members is accomplished.

Next, the appearance inspection is conducted under microscope after the welding operation to confirm whether the welded portion 200 is welded uniformly and also to confirm whether the lubricating fluid is leaking or not (step S2).

Next, in order to remove the contamination, etc. attached on the welded portion 200, the high-pressure air is blown to the welded portion 200 (step S3).

Next, the helium leak test of vacuum chamber type is conducted to confirm the presence or absence of the pores in the welded portion 200 (step S4).

Next, the process is a covering process of a surface of the welded portion 200 (step S5). This covering process includes a method of covering oil repellant or a remelting process of the welded portion 200 slightly with laser beam having a smaller energy, both of which are described below.

First, the covering process of covering the oil repellant is explained.

The covering process of covering the oil repellant has a solidifying process of solidifying the oil repellant covering the surface of the welded portion 200.

The oil repellant in liquid phase at normal temperature is covered uniformly on the surface of welded portion 200. Finally, the surface of the welded portion 200 is heated to solidify the oil repellant (step S6). The oil repellant used in this invention is in liquid state at normal temperature, and therefore, the oil repellant filled in the pores and forming a boundary surface may leave the pores under a shock, etc. By heating and hardening, however, the oil repellant can be held in the pores and prevented from leaving the pores under a shock, etc. Step S6 is intended to solidify the oil repellant, and any appropriate method other than heating can be employed for solidifying. For example, air is shut off or the ultraviolet light is radiated on the welded portion 200 after covering for the purpose of solidifying.

By covering the oil repellant at step S5, the pores which may exist in the welded portion 200 are intruded by the oil repellant and filled up under the surface tension thereof. The oil repellant is solidified at step S6 so that the filled portion is completely buried and eliminates the gaps due to the pores. As a result, the lubricating fluid otherwise tending to leak out of the motor from the pores cannot so leak out in the absence of the gaps.

The covering of the oil repellant before the welding process is meaningless in the absence of pores. The sole purpose of the oil repellant is to fill the gaps of the pores generated by the welding process and prevent the leakage of the lubricating oil out of the motor. Therefore, the oil repellant is covered always after the welding process.

Next, the remelting process of remelting of the surface of the welded portion 200 to a small depth again by the laser beam with a lower energy is explained.

The remelting process of remelting of the surface of the welded portion 200 has the solidifying process of solidifying of the surface of the remelted portion of the welded portion.

The energy of the laser beam is decreased to such a level that the surface of the welded portion 200 is slightly melted. After the welding process, the welded portion 200 is uniformly applying to the laser beam and the openings of the pores are melted. By the solidifying process as a cooling, the pores are solidified as melted state. As the result, the pores are closed. Thus, the lubricating fluid loses the way out, and cannot leak out of the motor. In this case, the oil repellant is not used, and therefore the hardening step S6 is not required.

Next, the spindle motor using this welding method according to an embodiment is explained with reference to FIG. 3.

A shaft 1 is a cylindrical stationary member, on the outer periphery of which a hollow cylindrical sleeve 2 formed with depressions on the axially upper and lower sides thereof is arranged in slightly spaced opposed relation to the outer peripheral surface of the shaft 1. The axially upper and lower sides of the sleeve 2 have an upper depression 21 and a lower depression 22, respectively, in which an upper bush 31 and a lower bush 32 are arranged in slightly spaced opposed relation to each other.

A hub 4 is formed with an inner cylindrical portion 41 and an outer cylindrical portion 42. The inner peripheral surface of the inner cylindrical portion 41 and the outer peripheral surface of the sleeve 2 are fixed to each other. A yoke 5 of a magnetic material is fixed on the axially lower side of the outer cylindrical portion 42, and a magnet 7 is fixed on the inner peripheral surface of the yoke 5.

An upper seal 61 and a lower seal 62 are fixedly welded to the axially upper end 43 and the axially lower end 44, respectively, of the hub 4. The oil repellant is coated over the entire periphery of the weld zone 400. The upper seal 61 and the lower seal 62 are in slightly spaced opposed relation to the upper bush 31 and the lower bush 32, respectively. The upper seal 61 and the lower seal 62 are each formed in slightly spaced opposed relation to the outer peripheral surface of the shaft 1.

The lubricating fluid 600 is filled in the minuscule gap between the shaft 1 and the sleeve 2, the minuscule gap between the sleeve 2 and the upper bush 31 and the lower bush 32, the minuscule gap between the upper bush 31 and the upper seal 61 and the minuscule gap between the lower bush 32 and the lower seal 62. A gas-liquid phase interface is formed in the minuscule gap between upper bush 31 and the upper seal 61 and the minuscule gap between the lower bush 32 and the lower seal 62.

The base 8 is formed with a through hole 81 at the central portion thereof, and the lower end 11 of the shaft 1 is fixed in the through hole 81.

The stator 9 is fixed on a stator mounting portion 82 of the base 8, and arranged in radially spaced opposed relation to the magnet 7.

According to this embodiment, the rotary member is configured of the sleeve 2, the hub 4, the yoke 5, the upper seal 61, the lower seal 62 and the magnet 7. The stationary member, on the other hand, is configured of the shaft 1, the upper bush 31, the lower bush 32, the base 8 and the stator 9. The dynamic bearing mechanism is formed between the upper bush 31 and the lower bush 32 and the axially upper end 43 and the axially lower end 44 of the hub 4. A dynamic pressure generating portion is formed on the opposed surfaces of the upper bush 31 and the axially upper end 43 and the opposed surfaces of the lower bush 32 and the axially lower end 44. By filling the lubricating fluid 600, the stationary member rotatably supports the rotary member through the lubricating fluid 600.

Next, the relation of the weld zone 400 between the upper seal 61 and the axially upper end 43 of the hub 4 with the oil repellant 700 is explained by comparison with the conventional case in which the repellant 700 is not coated.

In FIG. 5, upon generation of the pore 500 in the weld zone 400, the lubricating fluid 600 tends to leak out of the motor into a dry area through the pore 500. In the case where the oil repellant 700 is covering in the pore 500 as shown in FIG. 4, however, the lubricating fluid 600 is repelled back into the motor by the oil repellant 700. As a result, the lubricating fluid 600 is prevented from leaking out of the dry area by the oil repellant 700. In this way, a reliable motor having no effect on the magnetic disk is provided.

This principle similarly applies to the method of the remelting process by the laser beam with lower energy after the welding process in which the pore 500 is also effectively closed.

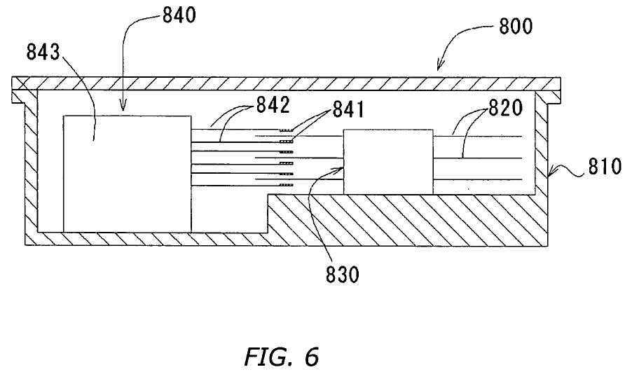

The recording disk driving apparatus using the spindle motor according to the invention is explained with reference to FIG. 6.

The recording disk driving apparatus 800 includes a rectangular housing 810, the interior of which is formed with a clean space (dry area) substantially free of dust and dirt. The spindle motor 830 having a circular hard disk 820 mounted thereon for recording the information is arranged in the dry area.

In the housing 810, a head moving mechanism 840 for reading and writing information from and into the hard disk 820 is arranged and configured of a magnetic head 841 for reading and writing information on the hard disk 820, an arm 842 for supporting the magnetic head 841 and an actuator 843 for moving the magnetic head 841 and the arm 842 to the desired position on the hard disk 820.

The spindle motor 830 shown in FIG. 3 is used for the recording disk driving apparatus 800. While securing a sufficient function, therefore, the recording disk driving apparatus 800 can reduced in size and thickness on the one hand and improved in reliability and endurance at the same time.

This invention is not limited to the aforementioned embodiments and can be variously modified or altered without departing from the scope of the invention.

The spindle motor according to an embodiment of the invention, for example, is not limited to the welding of the upper seal 61 and the lower seal 62 to the axial upper end 43 and the axial lower end 44 of the hub 4. This invention is applicable also to the welding of the coupling portion between the members in contact with the lubricating fluid.

As another example, the invention is not limited to the method in which the oil repellant is coated as a process of sealing the pore according to an embodiment. Alternatively, an adhesive or resin other than the oil repellant may be used.

Also, instead of the welding process used the laser beam described in the embodiments of the invention, other welding processes such as TIG arc welding or resistance welding can be employed with equal effect.

Further, the invention is not limited to the rotary member, the stationary member and the component members of the dynamic bearing mechanism designated in the embodiments of the invention. As an alternative, the rotary member may be any one rotating when the motor is driven. Similarly, the stationary member may alternatively be any member which is stationary when the motor is driven. The dynamic bearing mechanism may assume any member which performs the function as a mechanism to support the rotary member rotatably through the lubricating fluid.

What is claimed is:

1. A method of fabricating a spindle motor including a stationary member, a rotary member rotatably supported on the stationary member and a dynamic bearing mechanism formed by bearing surfaces of the stationary member and the rotary member and lubricating fluid interposed between, wherein a welded portion is formed on at least selected one of the stationary member and the rotary member, and the welded portion keeps apart the lubricating fluid from a dry area outside of the bearing where no lubricating fluid is touching the surface of the member, the method comprising:
a welding process of welding one of said members at a predetermined portion to from said welded portion by applying heat from a surface of the dry area;
a covering process of covering at least a part of the surface of said welded portion by putting solidifiable liquid material thereon, the surface being surrounded by said dry area; and
a solidifying process of solidifying said liquid material covering the surface of said welded portion.

2. A method of fabricating a spindle motor including a stationary member, a rotary member rotatably supported on the stationary member and a dynamic bearing mechanism formed by bearing surfaces of the stationary member and the rotary member and lubricating fluid interposed between, wherein a welded portion is formed on at least selected one of the stationary member and the rotary member, and the welded portion keeps apart the lubricating fluid from a dry area outside of the bearing where no lubricating fluid is touching the surface of the member, the method comprising:
a welding process of welding one of said members at a predetermined portion to from said welded portion by applying heat from a surface of the dry area;
a remelting process of remelting at least a part of a surface of said welded portion by applying heat thereon, the surface being surrounded by said dry area; and
a solidifying process of solidifying said remelted portion of said welded portion.

3. A method of fabricating a spindle motor according to claim 1, wherein said solidifiable liquid material is a solution made by dissolving oil repellant material into organic solvent.

4. A method of fabricating a spindle motor according to claim 1, wherein said solidifiable liquid material is adhesive.

5. A method of fabricating a spindle motor according to claim 1, wherein said solidifiable liquid material is resin which is hardened after covering said surface of said welded portion.

6. A method of fabricating a spindle motor according to claim 1, wherein focused energy beam is applied to said predetermined portion for applying said heat.

7. A method of fabricating a spindle motor according to claim 1, wherein focused energy beam is applied to said predetermined portion for applying said heat.

8. A method of fabricating a spindle motor according to claim 1, wherein focused energy beam is applied to a surface of said welded portion for remelting said surface.

9. A method of fabricating a spindle motor according to claim 8, wherein said welding process is carried out along a predetermined welding line and moving from a starting point toward a finish point by applying a focused energy beam with a progressively smaller energy of the beam from that of the portion of the starting point.

10. A method of fabricating a spindle motor according to claim 1, wherein inert gas is supplied aiming said welded portion during at least said welding process.

11. A method of fabricating a spindle motor according to claim 2, wherein inert gas is supplied aiming said welded portion during at least said welding process.

12. A method of fabricating a spindle motor according to claim 2, wherein inert gas is supplied aiming said welded portion during at least said remelting process.

13. A method of fabricating a spindle motor according to claim 10, wherein said inert gas is nitrogen.

14. A method of fabricating a spindle motor according to claim 11, wherein said inert gas is nitrogen.

15. A method of fabricating a spindle motor according to claim 12, wherein said inert gas is nitrogen.

16. A recording disk driving apparatus having mounted thereon a spindle motor including a member used for the coupling method according to claim 1, comprising:
a recording disk fixed on the rotary member and rotated on the same axis as the rotary shaft;
a magnetic head for magnetically writing/reading information on the recording disk;
an arm for supporting the magnetic head;
an actuator adapted to move the magnetic head and the arm along the peripheral direction; and
a housing for accommodating all the members described above.

17. A recording disk driving apparatus having mounted thereon a spindle motor including a member used for the coupling method according to claim 2, comprising:
a recording disk fixed on the rotary member and rotated on the same axis as the rotary shaft;
a magnetic head for magnetically writing/reading information on the recording disk;
an arm for supporting the magnetic head;
an actuator adapted to move the magnetic head and the arm along the peripheral direction; and
a housing for accommodating all the members described above.
